(19) United States
(12) Patent Application Publication
(10) Pub. No.: US 2005/0018288 A1
(43) Pub. Date: Jan. 27, 2005

(54) Stereoscopic display apparatus and system

(76) Inventor: Peter-Andre Redert, Eindhoven (NL)

Correspondence Address: Philips Corporation;Intellectual Property Department, P O Box 3001, Briarcliff Manor, NY, 10510, US

(21) Appl. No.: 10/498,294

(22) PCT Filed: Dec. 5, 2002
(86) PCT No.: PCT/IB02/05192

(30) Foreign Application Priority Data
Dec. 14, 2001 (EP) 01204850.0

(51) Int. Cl. G02B 27/22

(52) U.S. Cl. 359/462

(57) ABSTRACT

The stereoscopic display apparatus (300) comprises a source of illumination (101, 103) for emitting light, an imaging system (104) for imaging the source of illumination at a viewing region, a spatial light modulator (106) for modulating light from the source of illumination (101, 103) with two-dimensional images, and a control unit (108) for controlling a relative position of the “active” source of illumination (101, 103) related to the imaging system (104). The stereoscopic display apparatus (300) further comprises means to vary the relative position of the “active” source of illumination (101, 103) in three directions which are orthogonal to each other, without physically moving a light source (302-310) for inducing the source of illumination (101, 103) to emit light

The invention relates to an stereoscopic display apparatus comprising:

a first set of sources of illumination for emitting light, with the sources of illumination disposed on a first surface, with each source of illumination having a state of emitting light and a state of not emitting light;

a light source for inducing a particular source of illumination to emit light;

an imaging system for imaging the particular source of illumination at a viewing region;

a spatial light modulator for modulating light from the particular source of illumination with a two-dimensional image; and

a control unit for selecting the particular source of illumination from the first set of sources of illumination in order to put the particular source of illumination in the state of emitting light;

The invention further relates to an stereoscopic display system comprising:

an observer tracking system for tracking a position of an observer; and

such stereoscopic display apparatus.

An embodiment of a stereoscopic display system of the kind described in the opening paragraph is known from the European patent application EP 0 656 555. In that application it is disclosed that left eye and right eye images are displayed on LCD spatial light modulators which are illuminated by moveable light sources via converging lenses or mirrors. A tracking system tracks the position of an observer and a control system controls the position of the light sources. Hence, the images of the light sources formed by the lenses or mirrors follow the observer. The observer sees a 3D image while having freedom to move in a region bounded by a range of predetermined distances to the autostereoscopic display apparatus. In other words the observer has relatively much freedom to move e.g. horizontally and vertically, however the observer has limited freedom to move in a longitudinal direction which results in changing the distance towards the stereoscopic display apparatus.

It is an object of the invention to provide a stereoscopic display apparatus of the kind described in the opening paragraph which allows the observer to move in three directions while observing the 3D images.

The object of the invention is achieved in that the stereoscopic display apparatus comprises a second set of sources of illumination for emitting light, with these sources of illumination disposed on a second surface, not coinciding with the first surface, and that the control unit is designed to select the particular source of illumination also from the second set of sources of illumination. A major aspect of the invention is that the relative position of the “active” source of illumination can be varied in three directions. With “active” source of illumination is meant the source of illumination which is in the state of emitting light. Another aspect is that this can be achieved without physically moving the position of a light source for inducing the particular source of illumination to emit light. A movement of the light source is simulated by selecting the particular source of illumination. In EP 0656555 it is disclosed that the relative position of the “active” source of illumination can be varied in two directions by using a two-dimensional array of contiguous individually controllable light sources. However it is not disclosed that the “active” source of illumination can be moved in a third direction in a similar way. It is even suggested that movement in a third, longitudinal direction is not required. Instead of describing means to modify the relative position of the “active” source of illumination in a longitudinal direction, it is described that the effective size of the “active” source of illumination is adapted by means of incorporating an additional spatial light modulator in the illuminator.

An advantage of the stereoscopic display apparatus according to the invention is that the observer can observe 3D images in a relatively large range of longitudinal distances from the stereoscopic display apparatus. Embodiments of the stereoscopic display apparatus according to the invention comprise means to emit light on a controllable location within a three-dimensional volume. Some of these means correspond to a stereoscopic display apparatus themselves. The disadvantage of these types of stereoscopic display apparatus as such is the limited scaling capabilities. This is not in issue in the cases that they are applied as means to emit light on a controllable location within a three-dimensional volume.

Notice that a source of illumination is an abstraction. It is a location from which light is emitted. The light can be generated at that location but in many of the cases described in this disclosure the light is generated by a light source which is located somewhere else. By means of reflection or selective absorption the generated light is directed to and/or via the source of illumination. In these latter cases, the light is emitted from the source of illumination although it originates from a remote light source.

An embodiment of the stereoscopic display apparatus according to the invention comprises a three-dimensional structure of multiple light sources, with each of the multiple light sources having dimensions which are relatively small compared to mutual distances between neighbors of the multiple light sources. It is important that the volume comprising the light sources is substantially transparent. Otherwise a portion of the light sources would block a relatively large amount of the light emitted by one of the light sources. Transparency is achieved by disposing the light sources in a three dimensional grid with relatively large distances between the light sources. For the same reason, the dimensions of the wiring are also relatively small. Preferably these light sources are light emitting diodes (LED's). LED's are relatively cheap and are able to emit relatively much light.

Another embodiment of the stereoscopic display apparatus according to the invention comprises a stack of sheets, each of the sheets comprising a two-dimensional array of contiguous individually controllable sources of illumination. It is preferred to use sheets comprising materials of which the optical properties can be adapted by applying appropriate potential differences on the sheets. Optical properties are e.g. transparency, reflectiveness and ability to absorb light. These types of sheets or plates are relatively cheap and addressing portions of the plates is relatively easy.

An embodiment of the stereoscopic display apparatus according to the invention comprises a material that can be switched between a state of being substantially transparent and the state of emitting light. Hence the controllable sources of illumination are arranged to be switched between a first state of being substantially transparent and a second state of emitting light. As described above, transparency is required to prevent that a portion of the sources of illumination absorb light emitted by one of the sources of illumination. Preferably the material comprises a LC polymer gel. Alternatively the stack comprises plastic foil displays.

In an embodiment of the stereoscopic display apparatus according to the invention the light source is located at an edge of the particular sheet to lead in light in the particular sheet and which light is emitted at a particular location of the particular sheet which corresponds with the particular source of illumination, towards the spatial light modulator. The light passes along the particular sheet like in a glass-fiber. At the particular location the material is made diffuse temporarily. As a result the light will exit the sheet at that particular location. The article “Dynamic contrast filter to improve the luminance contrast performance of cathode ray tubes”, by H. de Koning et al. in IDW2000 Proceedings of 7th International Display Workshop describes a mixture of Polymer LC gel and ink which is used to switch between two states: transparent and black. Without ink it is possible to switch between transparent and diffuse.

In another embodiment of the stereoscopic display apparatus according to the invention the light source is located such that light generated by the light source is reflected at a particular location of the particular sheet which corresponds with the particular source of illumination, towards the spatial light modulator. Preferably a number of spacious light sources which are arranged to produce diffuse light are applied to prevent that a first source of illumination causes a shadow for a second source of illumination.

In another embodiment of the stereoscopic display apparatus according to the invention the particular sheet comprises a material that can be switched between a first state of being substantially transparent and a second state of blocking light. In other words, the controllable sources of illumination are arranged to be switched between a first state of being substantially transparent and a second state of blocking light. In this case the light source is disposed behind the stack. Preferably the stack comprises liquid crystal displays (LCD's). A three-dimensional display according to this concept is disclosed in European patent application published under number 0928117. In fact, this embodiment of the stereoscopic display apparatus according to the invention comprises such a three-dimensional display system as source of illumination.

Another embodiment of the stereoscopic display apparatus according to the invention comprises a solid volume of optically transparent material and, as light sources, two lasers which are arranged to emit invisible laser beams through the solid volume to create visible light at an intersection of the laser beams via a photon upconversion process, with the intersection corresponding to the particular source of illumination. Typically the lasers are infrared lasers with different wavelengths. This concept of generating light is disclosed in U.S. Pat. No. 5,956,172. In that document a three-dimensional display system using a two-photon upconversion process in a polymer is disclosed. In fact, this embodiment of the stereoscopic display apparatus according to the invention comprises such a three-dimensional display system as source of illumination.

Another embodiment of the stereoscopic display apparatus according to the invention comprises a rotating sheet with a reflective surface which has a rotating speed which is synchronized with pulsed emission of light generated by the light source. Sources of illumination are located within the solid of revolution of the sheet. A three-dimensional display according to this concept is disclosed in the document specifying the patent JP-2000287225. In fact, this embodiment of the stereoscopic display apparatus according to the invention comprises such a three-dimensional display system as source of illumination.

Modifications of the stereoscopic display apparatus and variations thereof may correspond to modifications and variations thereof of the stereoscopic display system described.

These and other aspects of the stereoscopic display apparatus and of the stereoscopic display system according to the invention will become apparent from and will be elucidated with respect to the implementations and embodiments described hereinafter and with reference to the accompanying drawings, wherein:

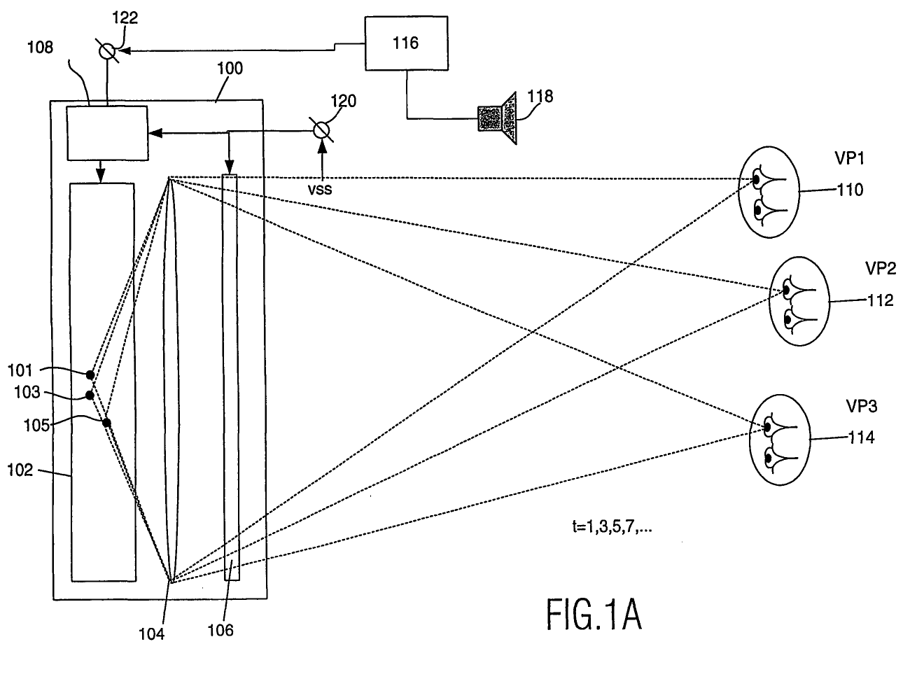

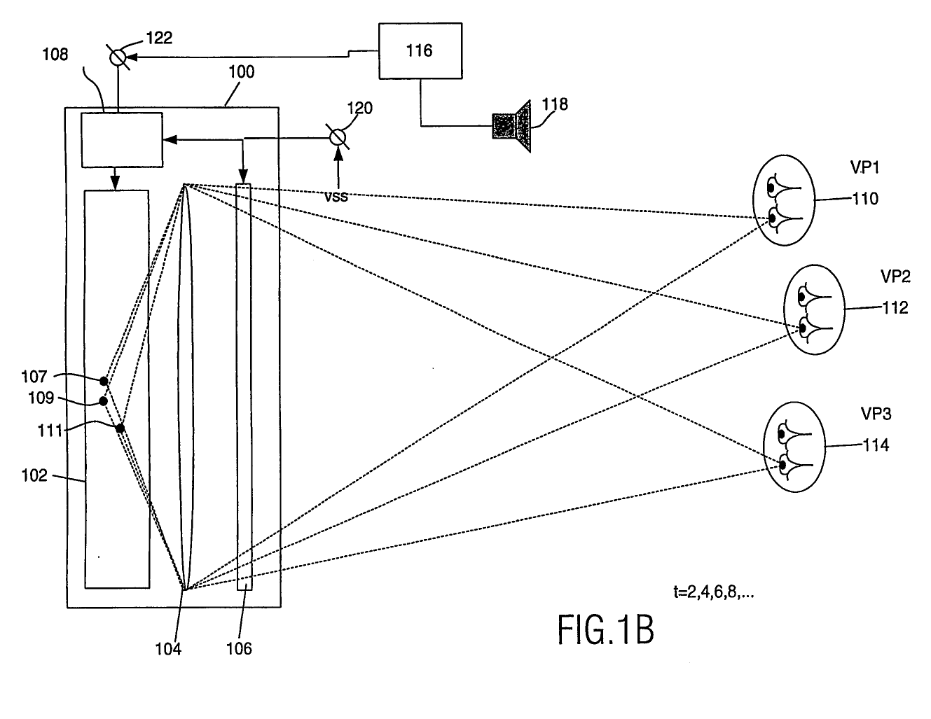

FIG. 1A and FIG. 1B schematically show an embodiment of an autostereoscopic display system with 3 observers seeing images with their right and left eyes, respectively;

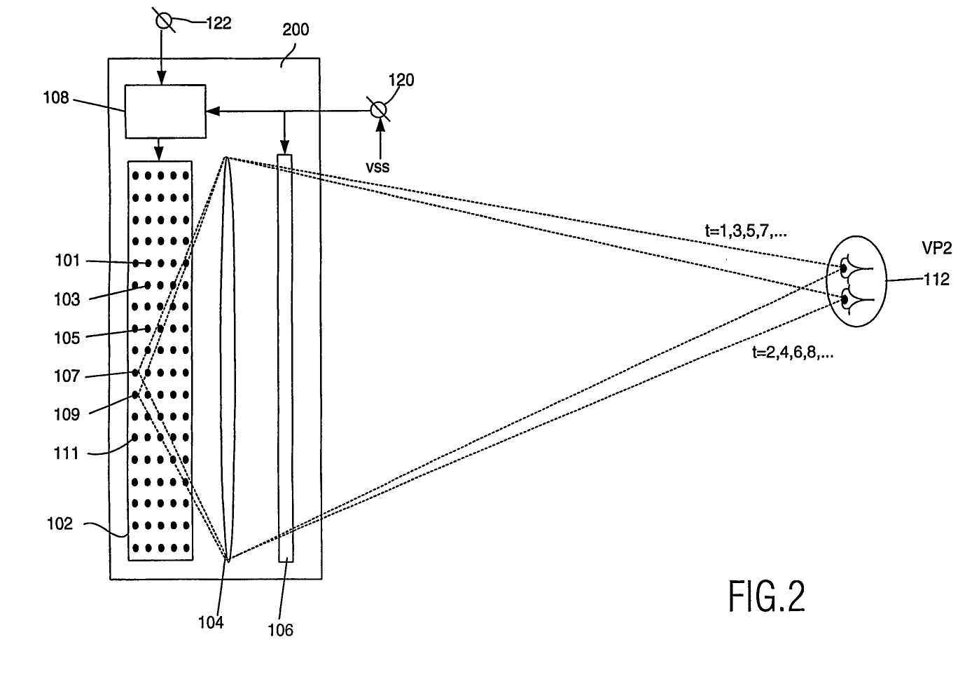

FIG. 2 schematically shows an embodiment of an autostereoscopic display apparatus with a 3D-backlight comprising a three-dimensional structure of multiple light sources;

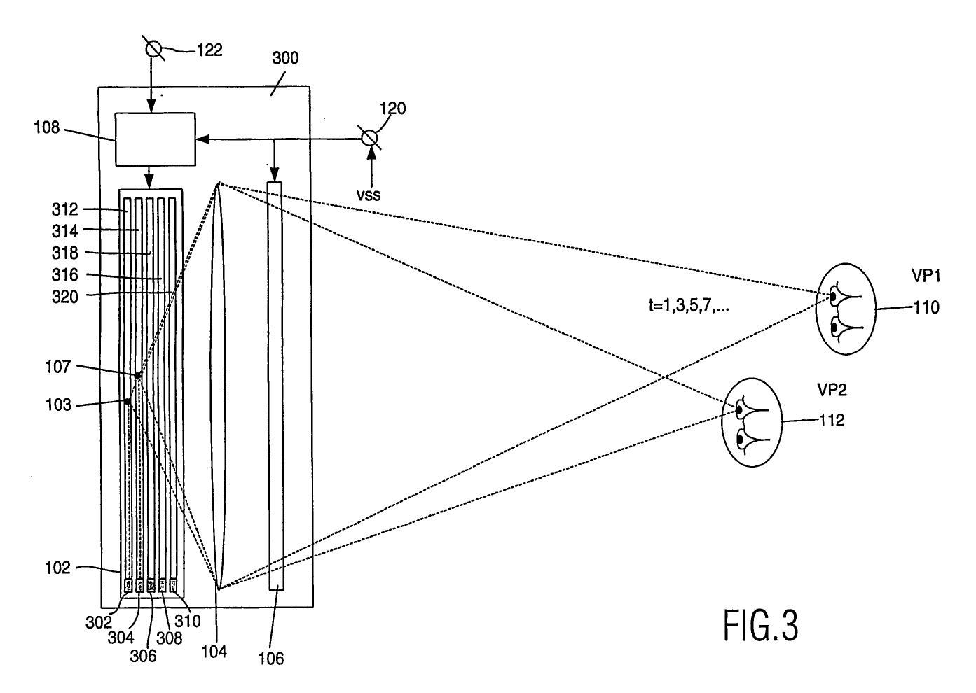

FIG. 3 schematically shows an embodiment of an autostereoscopic display apparatus with a 3D-backlight comprising light sources being located at the edges of the sheets of the stack of sheets;

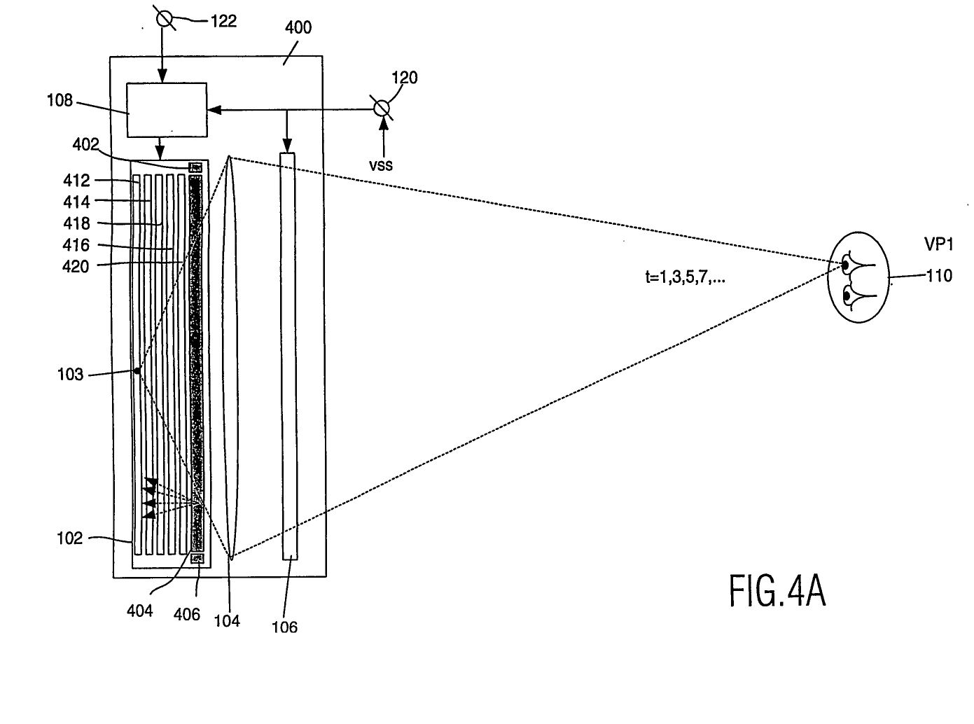

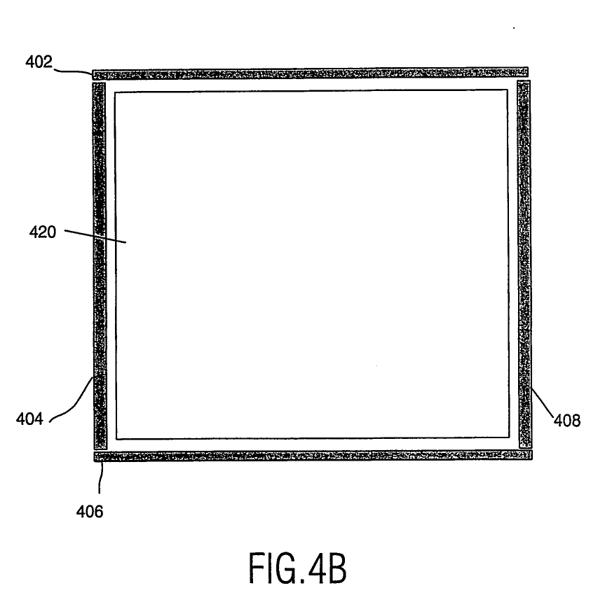

FIG. 4A schematically shows an embodiment of an autostereoscopic display apparatus comprising a 3D-backlight based on reflection by the sheets;

FIG. 4B schematically shows the light sources of the embodiment of FIG. 4A;

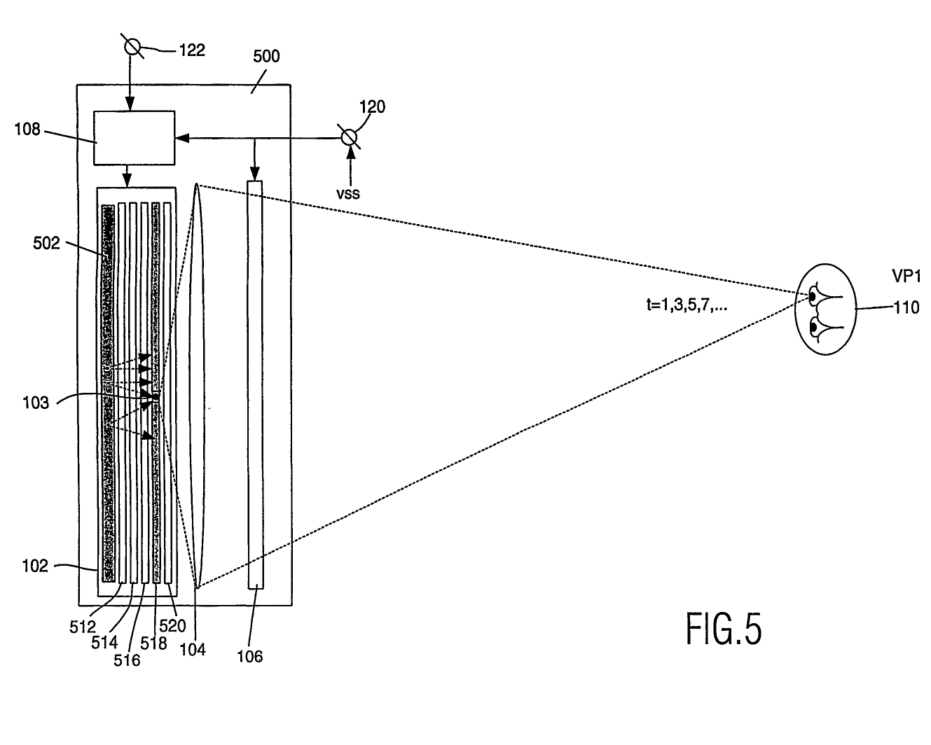

FIG. 5 schematically shows an embodiment of an autostereoscopic display apparatus comprising a 3D-backlight based on selective transfer of light;

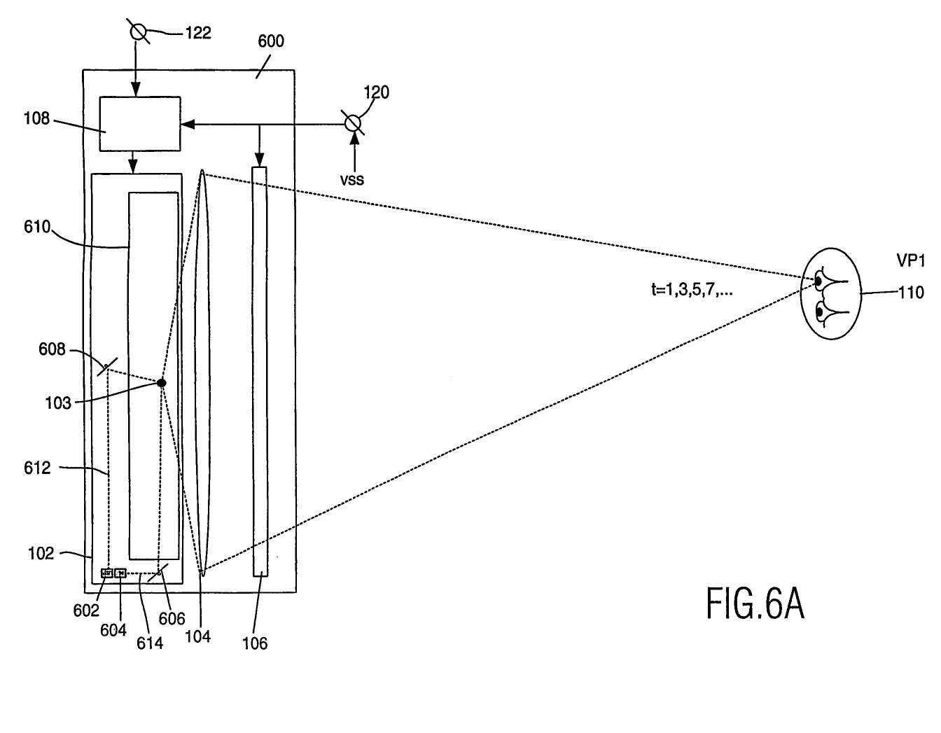

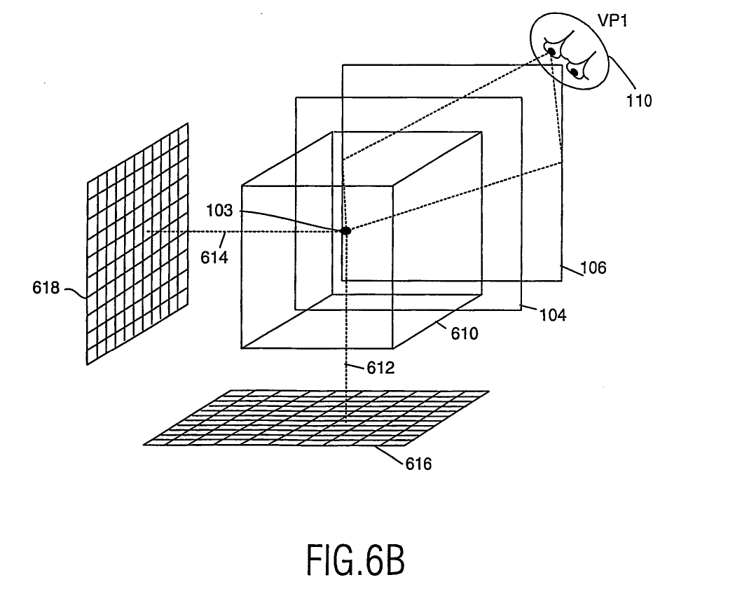

FIG. 6A schematically shows an embodiment of an autostereoscopic display apparatus with a 3D-backlight comprising a solid volume of optically transparent material and two infrared lasers;

FIG. 6B schematically shows an embodiment of an autostereoscopic display apparatus with a 3D-backlight comprising a solid volume of optically transparent material and two two-dimensional arrays of infrared lasers;

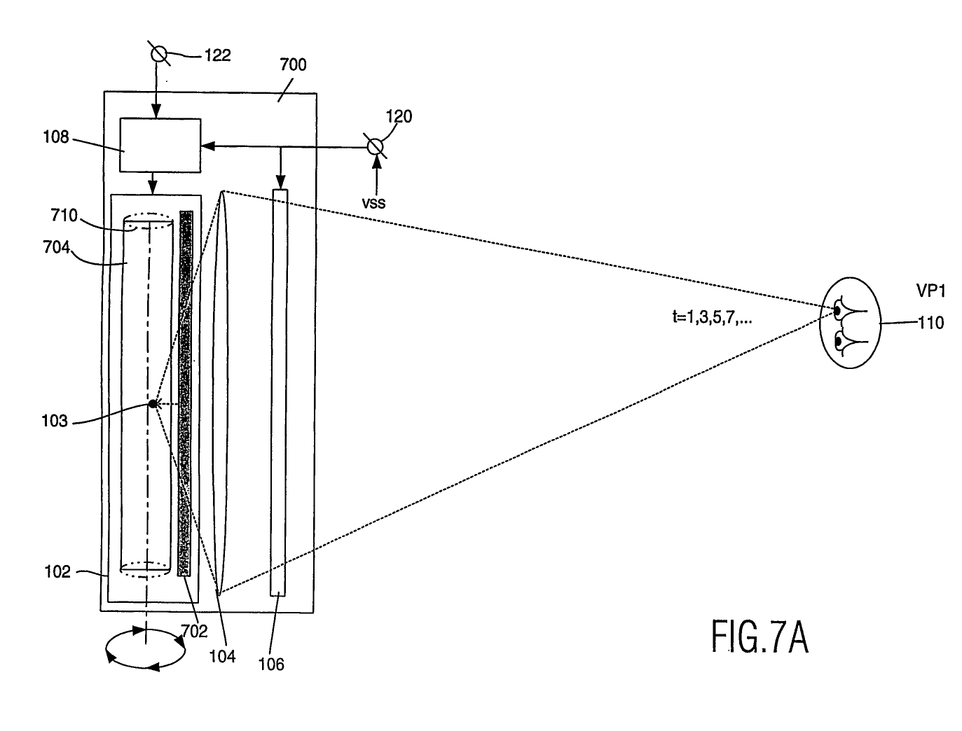

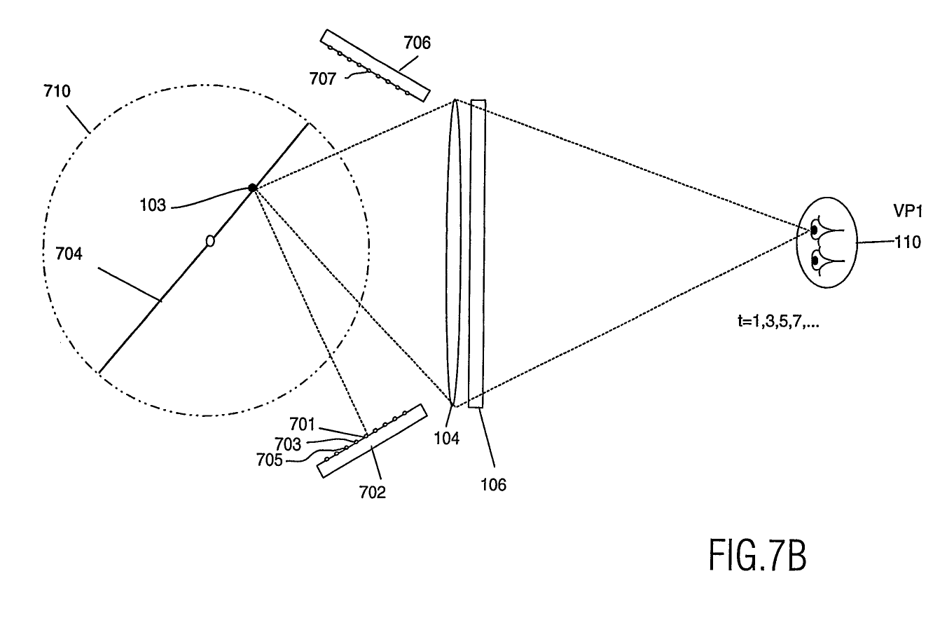

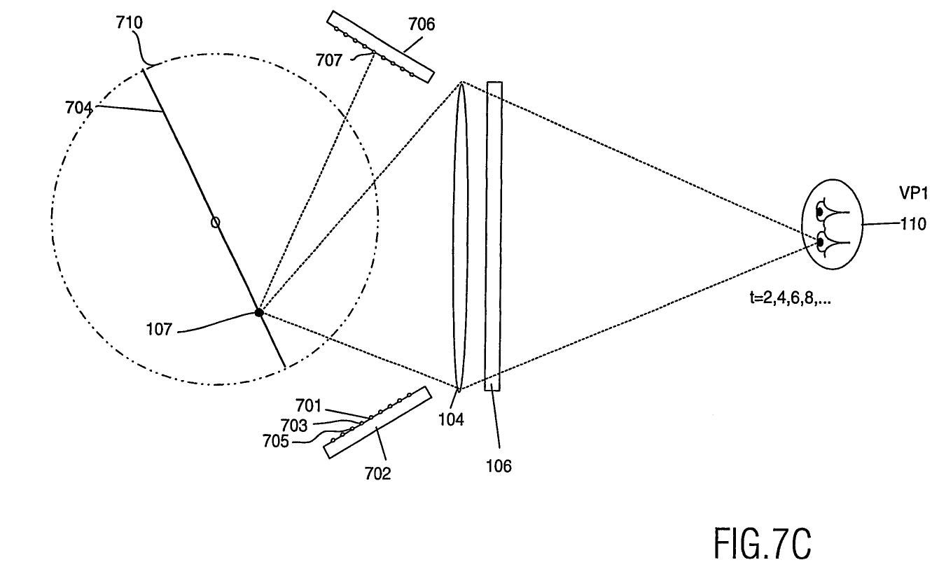

FIG. 7A schematically shows an embodiment of an autostereoscopic display apparatus with a 3D-backlight comprising a rotating sheet with a reflective surface;

FIG. 7B and FIG. 7C schematically show for a first and a second position of the rotating sheet, respectively, the direction in which light is emitted. Corresponding reference numerals have the same meaning in all of the FIGS.

FIG. 1A and FIG. 1B schematically show an embodiment of an autostereoscopic display system with 3 observers 110-114 seeing images with their right and left eyes, respectively. The autostereoscopic display apparatus 100 comprises:

a 3D back-light 102 for emitting light, e.g. by the sources of illumination 101, 103, 105 and 107, 109, 111 during time slots t=1, 3, 5, 7, . . . and t=2, 4, 6, 8 respectively. Hence, depending on the time-slot and on the position of observers it is selected which source or sources of illumination must be “active”.

a lens as imaging system 104 for imaging the source of illumination 101 at a viewing region. In this case a Fresnel lens is used.

an LCD as a spatial light modulator 106 for modulating light from the sources of illumination 101, 103, 105, 107, 109 and 111 with two-dimensional images;

a control unit 108 for controlling the relative positions of the “active” source of illumination 101, 103, 105, 107, 109 and 111 related to the lens 104.

The observer-adaptive autostereoscopic display apparatus 100 is capable of displaying M (typically M=1) original 3D video or TV programs in a time multiplex composite input video stream signal VSS to n=1, 2, . . . or N observers on an observer and image selective basis, as will be explained in more detail hereinafter. Each of those M original 3D video or TV programs entering the display apparatus 100 is composed of K original 3D images formed by 2D left and right eye views, each of those 2D left and right eye views being focused at the corresponding eyes of predetermined observers 110-114 at viewpoints VP1-VP3.

Such time multiplex composite input video stream signal VSS which is provided at the input connector 120, comprises a periodic sequence of pairs of images carrying pixel data of two-dimensional (2D) left and right eye views Vlij and Vrij of a 3D image IMij, in which i=1, 2 . . . K, being the number within a sequence of K 3D images constituting video program j, in which j=1, 2 . . . M, M being the total number of 3D TV programs, which are supplied to the spatial light modulator 106. The spatial light modulator 106 supplies view index data i,j of the left and right eye views Vlij and Vrij to a control unit 108 for synchronizing the 3D back-light 102 with the operation of the spatial light modulator 106. Optionally monoscopic data is provided instead of stereoscopic data.

The autostereoscopic display apparatus 100 is connected via its input connector 122 to an observer tracking system for tracking positions VP1, VP2 and VP3 of observers 110-114. The observer tracking system has a 3D eye localisator 118 for detecting the xyz co-ordinates of all observer's eyes individually within the viewing range of the autostereoscopic display apparatus 100. Each observer's position may be sensed by an ultrasonic tracking system or each observer 110-114 may wear a magnet to indicate his position to a magnetic tracking system. In a further embodiment one or more cameras may scan the viewing region to determine each observer's position, for instance supplying image data to a system which recognizes the eyes of each observer 110-114. In yet a further embodiment each observer 110-114 wears a reflector which reflects electromagnetic energy, such as infrared energy. A scanning infrared source and an infrared detector or a wide angle infrared source and a scanning infrared detector determine the position of each reflector which is preferably worn between the eyes of the observer 110-114.

The 3D eye localisator 118 is coupled to a view point control signal generator 116 providing a view point indicative control signal to the control unit 108. The control unit 108 generates a direction control signal using the view point indicative control signal and the view index data i,j and, which is supplied to the control unit 108 by the spatial light modulator 106. Under control of the direction control signal, the 3D back-light 102 emits light at the appropriate locations, i.e. by the sources of illumination 101, 103, 105, 107, 109 and 111. As a result, lightbeams carrying pixel data of the left and right eye views Vlij and Vrij are transferred to the corresponding eyes of a predetermined observer authorized to view the above video or TV program j. The control unit 108 decides for each of the eyes independently whether it can see an image or not. The 3D eye localisator 118 provides the control unit 108 with xyz co-ordinates of all eyes, so that the 3D back-light 102 can properly be adjusted by the control unit 108.

For the sake of clarity, the invention shall be described with reference to FIGS. 1A and 1B on the basis of a single 3D video or TV program being constituted of a series of 3D images IM1 to IMK, which is to be transmitted to three observers 110-114 at viewpoints VP1-VP3. Suppose each of the 3D images IM1 to IMK consists of 2D left and right eye views Vl1 to VlK and Vr1 to VrK, respectively, supplied to the spatial light modulator 106 in an alternate sequence of even and odd images occurring in even time slots t=0, 2, 4, . . . and odd timeslots t=1, 3, 5, . . . , respectively, of the above time multiplex composite input video stream signal VSS. Then in the even timeslots the spatial light modulator 106 is set in a left view mode to deal with left eye views Vli (i=1 . . . K) only by switching on 107, 109 and 111, as shown in FIG. 1B. In the odd timeslots the spatial light modulator 106 is set in a right view mode to deal with right eye views Vri (i=1 . . . K) only, as shown in FIG. 1A. For the display of a single 3D image IMk, the 2D left and right eye views Vlk and Vrk thereof occurring in timeslots 2(k-1) and 2k-1 respectively, the control unit 108 controls the 3D back-light 102 to focus all lightbeams carrying pixel data of the left eye views Vlk in the even timeslot 2(k-1) into a left view focus point or apex coinciding with the left eye viewpoints VP1-VP3 of observers 110-114 and to focus all lightbeams carrying pixel data of the right eye views Vlk in the odd timeslot 2k-1 into a right view apex coinciding with the right eye viewpoints VP1-VP3 of the observers 110-114. Synchronization in the alternate switching of the spatial light modulator 106 from the left view mode into the right view mode and vice versa, with time multiplexed transmission of the 2D left and right eye views Vli and Vri from the spatial light modulator 106 to the 3D back-light 102 is achieved with the view index data i supplied by the spatial light modulator 106 to the control unit 108. By using the above view point indicative control signal provided by the viewpoint tracker VT to dynamically adapt the left and right view apex to the actual position of the eyes of each viewer, a correctly distinct focus of the 2D left and right eye views Vl and Vr of all 3D images IM1 to IMK to the eyes of each of the observers 110-114 is obtained, resulting in a correct 3D image perception of the complete 3D video or TV program at all three view points VP1-VP3, independent from the observer's viewpoint and movement within the viewing range of the autostereoscopic display apparatus 100.

FIG. 2 schematically shows an embodiment of an autostereoscopic display apparatus 200 with a 3D-backlight 102 comprising a three-dimensional structure of multiple light sources as sources of illumination 101, 103, 105, 107, 109 and 111. The 3D-backlight 102 comprises a block of optically transmissive material. The material may comprise glass or a transparent plastics, such as Perspex. In the block a number of cavities is made. In each of these cavities a cathode fluorescent tube is placed. The light sources can be disposed in a regular grid. However this is not a prerequisite. The number of successive light sources in three directions can be mutual equal. But preferably the number of distinct light sources in a horizontal direction is relatively high compared to the number disposed in other directions. The probability of movements of observers in a horizontal direction is relatively high. Besides that, it is likely that in the case of multiple observers, these observers have their eyes at almost the same height. In the case that e.g. less light sources are disposed in a vertical direction, then these light source should be spacious in vertical direction.

Other possible light sources include light emitting diodes, lasers, incandescent light sources, light emitting polymers, luminescence and plasma sources. The light sources corresponding with the sources of illumination 107 and 109 are switched on alternatingly. During the time slots t=1, 3, 5, 7, . . . source of illumination 109 is switched on. During the time slots t=2, 4, 6, 8, . . . source of illumination 107 is switched on. If there are no observers watching simultaneously, no other sources of illumination will emit light during these time slots. This makes the autostereoscopic display apparatus 200 efficient with energy: only light is generated for particular directions. In other words no energy is wasted because the emission of light is “on demand”. In FIG. 2 it is depicted that the light generated at sources of illumination 107 and 109 is directed through the lens 104 and modulated in intensity by the spatial light modulator 106.

FIG. 3 schematically shows an embodiment of an autostereoscopic display apparatus 300 with a 3D-backlight 102 comprising light sources 302-310 being located at the edges of the sheets 312-320 of the stack of sheets. In FIG. 3 it is depicted that two observers simultaneously watch images generated by the autostereoscopic display apparatus 300. The emission of light is depicted for the time slots t=1, 3, 5, 7, . . . For observer 110 the light is generated by light source 302, lead into and passed along sheet 312 and emitted at the location of illumination source 103. For observer 112 the light is generated by light source 304, lead into and passed along sheet 314 and emitted at the location of illumination source 107. The optical properties of portions of the sheets 312 and 314 are different compared to other portions of the sheets 312 and 314, i.e. at the locations corresponding to the sources of illumination 103,107 the material is made diffuse and at other places the material is substantially transparent. As a result the light which is lead into a sheet 312-320 at an edge of such sheet is kept inside the sheet while it passes along the sheet. At the location of the sheet where the material is made diffuse the light exits the sheet. From this location, the light passes via the imaging system 104 and the spatial light modulator 106 in the direction of the eye of the observer 110 or 112. Optionally multiple light sources are attached to the sheets, e.g. a light source at each edge of a sheet. Alternatively multiple sheets share one light source.

FIG. 4A schematically shows an embodiment of an autostereoscopic display apparatus 400 comprising a 3D-backlight 102 based on reflection of light by the sheets 412-420. The working of this embodiment will be explained by means of an example. During time slots t=1, 3, 5, 7, . . . all sheets are transparent except a portion of sheet 412 which is temporarily made reflective. This portion corresponds with illumination source 103. As a result, light generated by one of the light sources 402-408 is reflected by this portion, i.e. at illumination source 103 and directed via the lens 104 and spatial light modulator 106 in the direction of the eye of the observer 110. Preferably the light sources 402-408 are spacious light sources which generate diffuse light. FIG. 4B schematically shows the light sources 402-408 of the embodiment of FIG. 4A. The light sources 402-408 are disposed such that reflected light, passing to the observer 110 is not obstructed by these light sources 402-408. This means that the light sources 402-408 are located in a kind of “ring” structure with a diameter which is larger than the dimensions of the sheets.

FIG. 5 schematically shows an embodiment of an autostereoscopic display apparatus 500 comprising a 3D-backlight 102 based on selective transfer of light. The 3D-backlight comprises a stack of LCD's 512-520. The elements of the LCD's 512-520 can be switched between transparent and blocking light. By switching most elements of an LCD 518, i.e. the entire area except a small portion, in the state of blocking light and one particular element in the state of being transparent, light can be passed selectively. Light is only emitted by that particular element, e.g. source of illumination 103. To prevent that an LCD e.g. 518 blocks light being emitted by a source of illumination which is located more closely to the light source 502 it is possible to perform time multiplexing in the control of the multiple LCDs. This is typically required in the case that multiple observers are watching the images generated by the autostereoscopic display apparatus 500. In that case it is for example possible to emit light from a first LCD 512 at the time slots t=1, 5, 9, 13, . . . for the right eye of observer 110 and to emit light from a second LCD 514 at the time slots t=3, 7, 11, 15 . . . . In this case it is assumed that the distances of the two observers toward the autostereoscopic display apparatus 500 differs that much, that using only one LCD, e.g. 512 for the right eyes of both observers does not result in satisfactory 3D images. Also for the left eyes a similar time-multiplexing should be applied.

FIG. 6A schematically shows an embodiment of an autostereoscopic display apparatus 600 with a 3D-backlight 102 comprising a solid volume 610 of optically transparent material and two infrared lasers 602 and 604. The invisible light generated by the lasers 602 and 604 is directed into the volume by means of mirrors, e.g. 606 and 608. The location of and freedom of rotation of the mirrors and lasers is such that the laser beams 612 and 614 can be directed through the entire solid volume. At the intersection of the laser beams 612, 614 inside the volume, visible light is generated by means of a two-photon upconversion process. This visible light is emitted via the lens 104 and the spatial light modulator 106 towards the observer 110.

FIG. 6B schematically shows an embodiment of an autostereoscopic display apparatus with a 3D-backlight comprising a solid volume 610 of optically transparent material and two two-dimensional arrays 616, 618 of infrared lasers. A system architecture is illustrated in which deflective scanning of laser beams, and all of the associated positioning feedback and accuracy requirements has been eliminated and replaced by two-dimensional arrays 616, 618 of vertical cavity surface emitting laser diodes. Each individual emitter on such an array 616, 618 is independently addressable and is simply modulated on or off to address voxels in the solid volume 610. The two-dimensional arrays 616, 618 are positioned on orthogonal faces of the solid volume 610.

FIG. 7A schematically shows an embodiment of an autostereoscopic display apparatus 700 with a 3D-backlight 102 comprising a rotating sheet 704 with a reflective surface. FIG. 7B and FIG. 7C schematically show for a first and a second position of the rotating sheet 704, respectively, the direction in which light is emitted. The autostereoscopic display apparatus 700 further comprises two two-dimensional arrays 702, 706 of light sources 701, 703, 705, 707. The light sources are arranged to generate light for predetermined time slots. These time slots are correlated with the angular position of the rotating sheet 704. Hence the generation of light and the rotation speed of the rotating sheet are synchronized. The result is that at positions within the solid of revolution 710 of the rotating sheet 704 light is emitted by means of reflection. In FIG. 7B it is depicted that light is generated by light source 701. This light is reflected by the rotating sheet 704 at the position which corresponds with source of illumination 103. The reflected light passes via the lens 104 and the spatial light modulator 106 towards the right eye of observer 110 at viewpoint VP1. As long as the observer 110 remains at viewpoint VP1 the light source 701 will emit light during the time slots t=1, 3, 5, 7, . . . . In FIG. 7C it is depicted that light is generated by light source 707. This light is reflected by the rotating sheet 704 at the position which corresponds with source of illumination 107. The reflected light passes via the lens 104 and the spatial light modulator 106 towards the left eye of observer 110 at viewpoint VP1. It will be clear that by applying multiple light sources 701, 703, 705, 707 simultaneously or time-multiplexed multiple observers can watch 3D images. Alternatively the arrays 702, 706 of light sources are replaced by single light sources which can be rotated or from which the emitted light is deflected by means of mirrors and lenses.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

Alternatively the order of the lens 104 and the spatial light modulator 106 is different from what is depicted in the FIGS. Besides the embodiments disclose based on time multiplexing, alternative arrangements are possible to view multiple images. E.g. by applying multiple 3-D backlights, multiple spatial light modulators, multiple lenses and mirrors.

1. A stereoscopic display apparatus (100, 200, 300, 400, 500, 600, 700) comprising:
a first set of sources of illumination (101, 103, 105) for emitting light, with the sources of illumination disposed on a first surface, with each source of illumination having a state of emitting light and a state of not emitting light;
a light source (302-310, 402-408, 502, 602, 604, 616, 618, 701-703, 705-707) for inducing a particular source of illumination to emit light;
an imaging system (104) for imaging the particular source of illumination at a viewing region;
a spatial light modulator (106) for modulating light from the particular source of illumination with a two-dimensional image; and
a control unit (108) for selecting the particular source of illumination from the first set of sources of illumination (101, 103, 105) in order to put the particular source of illumination in the state of emitting light; characterized in that the stereoscopic display apparatus (100, 200, 300, 400, 500, 600, 700) comprises a second set of sources of illumination (107, 109, 111) for emitting light, with these sources of illumination disposed on a second surface, not coinciding with the first surface, and that the control unit (108) is designed to select the particular source of illumination from the second set of sources of illumination.

2. A stereoscopic display apparatus (100, 200) as claimed in claim 1, characterized in comprising a three-dimensional structure of multiple light sources, with each of the multiple light sources having dimensions which are relatively small compared to mutual distances between neighbors of the multiple light sources.

3. A stereoscopic display apparatus (100, 200) as claimed in claim 2, characterized in that the multiple light sources are light emitting diodes.

4. A stereoscopic display apparatus (100, 300, 400, 500) as claimed in claim 1, characterized in comprising a stack of sheets (312-320, 412-420, 512-520), each of the sheets (312-320, 412-420, 512-520) comprising a two-dimensional array of contiguous individually controllable sources of illumination (101, 103, 105, 107, 109, 111).

5. A stereoscopic display apparatus (100, 300, 400, 500) as claimed in claim 4, characterized in that a particular sheet (312-320, 412-420, 512-520) comprises a material that can be switched between a state of being substantially transparent and the state of emitting light.

6. A stereoscopic display apparatus (100, 300, 400, 500) as claimed in claim 4, characterized in that the material is a LC polymer gel.

7. A stereoscopic display apparatus (100, 300, 400, 500) as claimed in claim 4, characterized in that the stack comprises plastic foil displays.

8. A stereoscopic display apparatus (100, 300) as claimed in claim 5, characterized in that the light source (302-310) is located at an edge of the particular sheet (312-320) to lead light into the particular sheet (312-320) and which light is emitted at a particular location of the particular sheet which corresponds with the particular source of illumination (101, 103), towards the spatial light modulator (106).

9. A stereoscopic display apparatus (100, 400) as claimed in claim 5, characterized in that the light source (402-408) is located such that light generated by the light source (402-408) is reflected at a particular location of the particular sheet which corresponds with the particular source of illumination (103), towards the spatial light modulator (106).

10. A stereoscopic display apparatus (100, 500) as claimed in claim 4, characterized in that a particular sheet (512-520) comprises a material that can be switched between a first state of being substantially transparent and a second state of blocking light.

11. A stereoscopic display apparatus (100, 500) as claimed in claim 10, characterized in that the stack comprises liquid crystal displays.

12. A stereoscopic display apparatus (100, 600) as claimed in claim 1, characterized in comprising a solid volume (610) of optically transparent material and, as light sources, two lasers (602, 604) which are arranged to emit laser beams (612, 614) through the solid volume (610) to create visible light at an intersection of the laser beams via a photon upconversion process, with the intersection corresponding to the particular source of illumination (103).

13. A stereoscopic display apparatus (100, 700) as claimed in claim 1, characterized in comprising a rotating sheet (704) with a reflective surface which has a rotating speed which is synchronized with pulsed emission of light generated by the light source (702).

14. A stereoscopic display system comprising:
a first set of sources of illumination (101, 103, 105) for emitting light, with the sources of illumination disposed on a first surface, with each source of illumination having a state of emitting light and a state of not emitting light;
a light source (302-310, 402-408, 502, 602, 604, 616, 618, 701-703, 705-707) for inducing a particular source of illumination to emit light;
an imaging system (104) for imaging the particular source of illumination at a viewing region;
a spatial light modulator (106) for modulating light from the particular source of illumination with a two-dimensional image;
a control unit (108) for selecting the particular source of illumination from the first set of sources of illumination (101, 103, 105) in order to put the particular source of illumination in the state of emitting light; and
an observer tracking system (116, 118) for tracking a position of an observer (110, 112, 114); characterized in that the stereoscopic display system comprises a second set of sources of illumination (107, 109, 111) for emitting light, with these sources of illumination disposed on a second surface, not coinciding with the first surface, and that the control unit (108) is designed to select the particular source of illumination from the second set of sources of illumination.
